(19) United States
(12) Patent Application Publication
(10) Pub. No.: US 2026/0361262 A1
(43) Pub. Date: Nov. 12, 2026

(54) PAD FOR SOLAR PANEL MODULE RAIL

(71) Applicant: Unirac, Inc., Albuquerque, NM (US)

(72) Inventors: Pedro Valdez, Holmes, NY (US); Gary Norman, Louisville, CO (US); Michael Serron, Arvada, CO (US)

(21) Appl. No.: 19/200,942

(22) Filed: May 7, 2025

(51) Int. Cl. H02S 20/24; F24S 25/60; F24S 25/61

(52) U.S. Cl. CPC H02S 20/24; F24S 25/61; F24S 2025/6002

(57) ABSTRACT

A first pad includes a first hook to engage a first side of a rail that supports a solar panel module, a second hook to engage a second side of the rail, a first protrusion to be at least partially disposed through a first slot of the rail, a second protrusion to be at least partially disposed through a second slot of the rail, the second protrusion being parallel to the first protrusion, a first receptacle to engage a first protrusion of a second pad, and a second receptacle to engage a second protrusion of the second pad.

### BACKGROUND

The solar power industry continues to grow and, as a result, installation time and integrity remain critical. Generally, mounts secure solar panel modules to a surface using fasteners. Alternatively, the mounts may rest on the surface and be secured using ballasts. The mounts, however, may damage the surface, thereby compromising a waterproofing nature of the surface. In addition, the mounts may be easily reoriented on the surface. In such instances, solar panel modules may be damaged and/or improperly positioned for solar energy capture.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features. The systems depicted in the accompanying figures are not to scale and components within the figures may be depicted not to scale with each other.

FIG. 1 illustrates an isometric view of an example pad configured to secure to a rail that supports one or more solar panel modules, according to an embodiment of the present disclosure.

FIG. 2 illustrates a top view of the pad of FIG. 1, according to an embodiment of the present disclosure.

FIG. 3 illustrates a bottom view of the pad of FIG. 1, according to an embodiment of the present disclosure.

FIG. 4 illustrates a side view of the pad of FIG. 1, according to an embodiment of the present disclosure.

FIG. 5 illustrates a side view of the pad of FIG. 1, according to an embodiment of the present disclosure.

FIG. 6 illustrates a cross-sectional view of the pad of FIG. 1, taken along line A-A of FIG. 3, according to an embodiment of the present disclosure.

FIG. 7 illustrates an isometric view of example assembly, including the pad of FIG. 1 and one or more spacer pads secured to the pad of FIG. 1, according to an embodiment of the present disclosure.

FIG. 8 illustrates a side view of the assembly of FIG. 7, according to an embodiment of the present disclosure.

FIG. 9 illustrates an isometric view of one of the spacer pads of FIG. 7, according to an embodiment of the present disclosure.

FIG. 10 illustrates a bottom view of one of the spacer pads of FIG. 7, according to an embodiment of the present disclosure.

FIG. 11 illustrates a cross-sectional view of the assembly of FIG. 7, taken along line B-B of FIG. 7, according to an embodiment of the present disclosure.

FIG. 12 illustrates an isometric view of an example rail that secures to the pad of FIG. 1, according to an embodiment of the present disclosure.

FIGS. 13 and 14 illustrate an example sequence to attach the rail of FIG. 12 to the pad of FIG. 1, according to an embodiment of the present disclosure.

FIG. 15 illustrates a side view of an attachment of the rail of FIG. 12 to the pad of FIG. 1, according to an embodiment of the present disclosure.

### DETAILED DESCRIPTION

This application is directed, at least in part, to a pad (e.g., apparatus, device, etc.) for a rail that is configured to support one or more solar panels above a surface, according to an embodiment of the present disclosure. In an embodiment, the pad may include a base on which the rail rests. One or more protrusions may extend from the base to engage with slots of the rail. Additionally, the pad may include one or more hooks that engage with sides of the rail. The engagement between the protrusions and the slots, as well as an engagement between the hooks and the sides of the rail, may secure the pad to the rail. The pad may serve as a protective interface (i.e., layer) between the rail and the surface to reduce damage to the surface. In addition, the pad may increase a coefficient of friction between the rail and the surface to prevent reorientation of the rail, and consequently, the solar panel modules on the surface.

In an embodiment, the base may include a top surface on which the rail is disposed. A bottom surface, opposite the top surface, may be disposed against the surface. The one or more protrusions and the one or more hooks may extend from the top surface. The one or more protrusions may represent ribs, knobs, projections, etc., that are configured to engage with the slots of the rail. The slots may represent channels, grooves, etc., formed in the rail. In an embodiment, the protrusions may be disposed through the slots, respectively, to seat the rail on the pad. For example, a first protrusion may be disposed through a first slot in the rail, and a second protrusion may be disposed through a second slot in the rail. The hooks may engaged with sides of the rail to prevent a disengagement between the rail and the pad. For example, a first hook may engage with a first side of the rail and a second hook may engage with a second side of the rail. The hooks may be biased from a resting state to permit insertion of the rail between the hooks. Generally, the base may define an area (e.g., receptacle) between the hooks in which the rail is retained.

Although described as including the one or more protrusions and the one or more hooks, the pad may include other attachment mechanisms, features, etc., to secure the rail and the pad together. For example, the pad may include key and keyway connections, male female connections, tabs, flanges, prongs, ribs, etc., that engage with suitable features of the rail to secure the rail to the pad. The pad may also include alignment mechanisms to seat the rail on the pad. In an embodiment, a configuration of the attachment mechanisms and/or the alignment mechanisms may be based at least in part on the rail, such as a shape of the rail, features of the rail (e.g., flanges, slots, etc.), and so forth. Moreover, a plurality of the pads may be secured along a length of the rail.

The base may also define receptacles into which protrusions (e.g., ribs, projections, etc.) of spacer pads are configured to be disposed. The receptacles may be disposed on the bottom surface of the base. The spacer pads may be used to space the pad, and therefore, the rail, above the surface. Additionally, or alternatively, in an embodiment, the spacer pads may be used to level the rail on the surface, orient the rail and any suitable angle to facilitate solar energy capture, and so forth. The base may include more than one of the receptacles to accommodate more than one of the protrusions of the spacer pads, respectively. For example, the base may include three of the receptacles for accommodating three of the protrusions of the spacer pads. In an embodiment, as an assembly, the pad and the spacer pads may be installed on the surface.

The receptacles may be arranged in any pattern, layout, configuration, etc., to orient the spacer pads on the pad. Additionally, the spacer pads may include a bottom surface having receptacles into which protrusions of the spacer pads are capable of being disposed for attaching the spacer pads together. In this sense, multiple spacer pads may be stacked together or attached to the pad. In an embodiment, the pad and the spacer pads may be similar. However, the spacer pads may not include the hooks, and/or the pad may include two of the protrusions for engaging with the rail, whereas the spacer pads may include three of the protrusions and three of the receptacles.

In an embodiment, the pad may be manufactured from materials that protect the surface and/or increase a coefficient of friction between the rail and the surface. Example materials include rubber, silicone, plastic, etc. Moreover, given that the spacer pads may be disposed against the surface, the spacer pads may be manufactured from similar materials as the pad.

The present disclosure provides an overall understanding of the principles of the structure, function, device, and system disclosed herein. One or more examples of the present disclosure are illustrated in the accompanying drawings. Those of ordinary skill in the art will understand and appreciate that the devices, the systems, and/or the methods specifically described herein and illustrated in the accompanying drawings are non-limiting embodiments. The features illustrated or described in connection with one embodiment or instance may be combined with the features of other embodiments or instances. Such modifications and variations are intended to be included within the scope of the disclosure and appended claims.

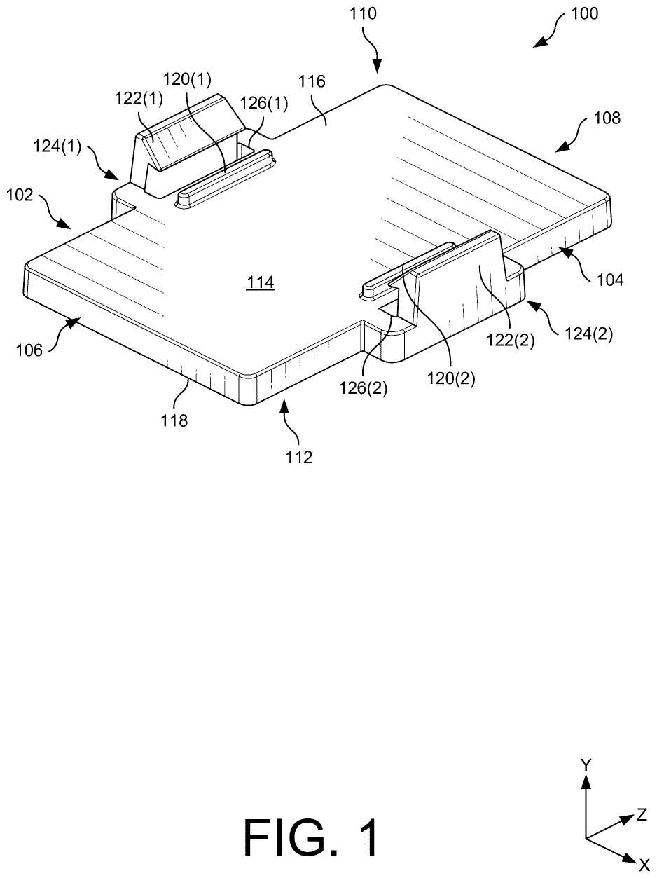

FIG. 1 illustrates an isometric view of an example pad 100 configured to support a rail above a surface, according to an embodiment of the present disclosure. As will be described herein, the rail may support one or more solar panel modules above the surface (e.g., roof), where the rail may rest on the pad 100. The solar panel modules may secure to the rail via mounts, brackets, clamps, etc. The rail may be disposed on, and supported by, the pad 100 to prevent damage to the surface (e.g., scratching, scoring, etc.) The pad 100 may include a first side 102, a second side 104 spaced apart from the first side 102 (e.g., in the X-direction), a third side 106, a fourth side 108 spaced apart from the third side 106 (e.g., in the Z-direction), a top 110, and a bottom 112 spaced apart from the top 110 (e.g., in the Y-direction). As will be explained herein, the bottom 112 may be disposed against, or rest on, the surface. Alternatively, the bottom 112 may be disposed against spacer pads for spacing the pad 100 above the surface. A width of the pad 100 may be defined as extending between the first side 102 and the second side 104. A length of the pad 100 may be defined as extending between the third side 106 and the fourth side 108. The width and the length may accommodate the rail.

The pad 100 may include a base 114 having a top surface 116 and a bottom surface 118. The rail that supports one of the solar panel modules may be disposed on or along the top surface 116. The bottom surface 118 may be disposed along the bottom 112 and configured to engage the surface and/or be disposed adjacent to the spacer pads. In an embodiment, the top surface 116 may be planar (e.g., about the X-Z plane). However, in an embodiment, the top surface 116 may be shaped differently to engage with, or seat, the rail on the base 114.

The pad 100 may include one or more features for engaging the rail. The features may engage the rail to seat the rail on the pad 100, to attach the rail to the pad 100, etc. In an embodiment, a shape, configuration, location, number, etc., of the features may be based at least in part on the specifics of the rail. Generally, these features may represent attachment or alignment mechanisms for securing the rail and the pad 100 together. While a specific variation of the attachment or alignment mechanisms is shown and described, the pad 100 may include any suitable male and female connectors, key and keyway connectors, etc., that are configured to engage with suitable male and female connectors, key and keyway connectors, etc., of the rail.

The pad 100 is shown including protrusions 120, such as a protrusion 120(1) and a protrusion 120(2). The protrusions 120 may be disposed along and extend above the top surface 116 of the base 114. The protrusions 120 may represent ribs, projections, spines, etc., that extend above the top surface 116. The protrusions 120 may be disposed through slots (e.g., channels, grooves, etc.) in the rail, for example, to seat the rail on the pad 100. A disposition of the protrusions 120 within the slots may prevent the rail 1200 from reorienting on the base 114. The protrusions 120 may extend in a first direction (e.g., Z-direction), where the first direction may be defined by a lengthwise direction of the protrusion 120(1) and the protrusion 120(2).

Although shown as including two of the protrusions 120, the pad 100 may include more than or less than two of the protrusions 120. Additionally, as introduced above, the shape, configuration, etc., of the protrusions 120 may be different than shown to accommodate the rail.

The pad 100 may also include hooks 122, such as a hook 122(1) and a hook 122(2), that engage with portions of the rail. The hooks 122 are shown extending from the base 114, above the top surface 116. The hooks 122 may engage with sides of the rail to secure the rail to the pad 100. For example, the hook 122(1) may engage with a first side of the rail and the hook 122(2) may engage with a second side of the rail. An area disposed between the hook 122(1) and the hook 122(2) may accommodate the rail (e.g., a width of the rail). The rail may therefore be disposed between the hook 122(1) and the hook 122(2).

In an embodiment, the pad 100 may be secured to the rail, and therein, as an assembly, the rail and the pad 100 may be placed on the surface. A plurality of the pads 100 may be disposed along a length of the rail. For example, along a lengthwise span of the rail, a plurality of the pads 100 may be attached to the rail. In an embodiment, the pads 100 may rest on the surface and a weight of the solar panel modules and/or ballasts may secure the solar panel modules on the surface. For example, ballasts may be disposed on the rail.

As will be explained herein and as introduced above, the pad 100 may be used in conjunction with the spacer pads that serve to level and/or space the rail above the surface. In these instances, the spacer pads may be disposed on the bottom 112 of the pad 100. As such, in an embodiment, the bottom 112 may not directly contact the surface, but instead, the bottom 112 may secure to the spacer pads. In such instances, the spacer pads may contact the surface. Any plurality of the spacer pads may be attached together to support the pad 100 above the surface.

The base 114 may include flanges 124 on which the hooks 122 are disposed. For example, the hook 122(1) may be disposed on or extend from the flange 124(1) and the hook 122(2) may be disposed on or extend from the flange 124(2). The hook 122(1) and the hook 122(2) may be oriented towards one another. The base 114 may include a channel 126(1) disposed through the flange 124(1) and a channel 126(2) disposed through the flange 124(2). The channels 126 may extend through the base 114, between the top surface 116 and the bottom surface 118. The channels 126 may permit the flanges 124 to be formed (e.g., via injection modeling) and/or may provide flexure to the hooks 122.

The pad 100 may be manufactured from injection molding, casting, stamping, etc. In an embodiment, the pad 100 may be manufactured from materials such as plastic, rubber, composites, metal, etc. The material of the pad 100 may prevent a reorientation of the pad 100 on the surface. Example materials include Santoprene 201-73, Elastocon 2870, Unisoft TPE ST-70A BK-2-01.

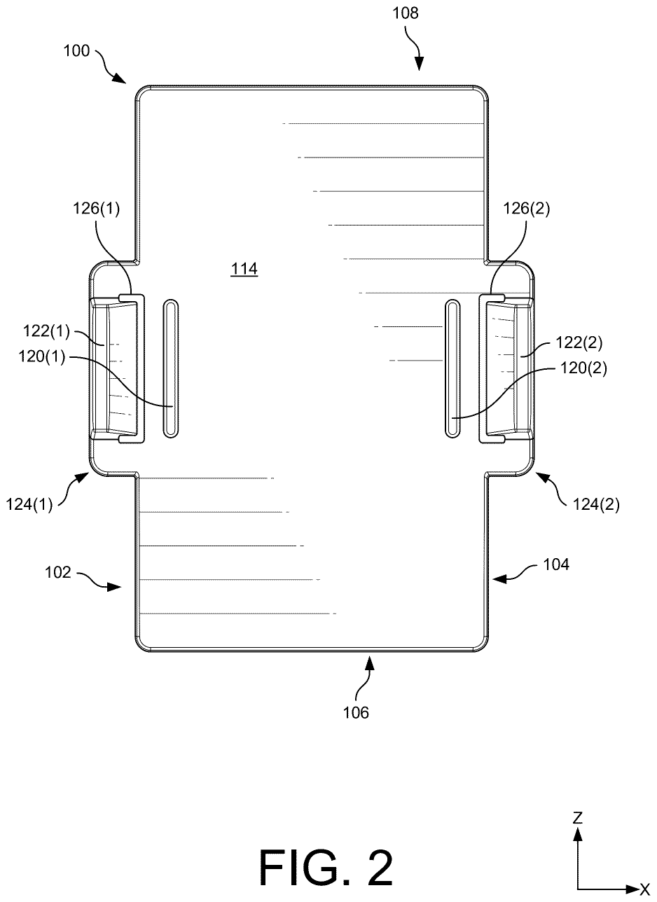

FIG. 2 illustrates a top view of the pad 100, according to an embodiment of the present disclosure. The pad 100, as introduced above, includes the base 114, the protrusions 120, and the hooks 122. The pads 100 and the hooks 122 may be disposed centrally between the third side 106 and the fourth side 108 The hook 122(1) is disposed along, or proximate to, the first side 102. The hook 122(2) is disposed along, or proximate to, the second side 104.

The protrusions 120 may include a length (e.g., in the Z-direction) and a width (e.g., in the X-direction). The length and the width of the protrusions 120 may be based at least in part on specifics of the rail (e.g., size of the slots in the rail). In addition, a distance disposed between the protrusions 120 (e.g., in the X-direction) may be based on specifics of the rail. In an embodiment, the protrusions 120 may include a different length or width as compared to one another, or may be shaped differently than shown. In an embodiment, the protrusions 120 may be parallel to one another. Moreover, the base 114 may include more than or less than two of the protrusions 120, and/or the protrusions 120 may be located differently than shown.

The hooks 122 may include a length (e.g., in the Z-direction), which may be the same as or different than the length of the protrusions 120. In an embodiment, the hooks 122 may be disposed on the flanges 124, such as the flange 124(1) and the flange 124(2), respectively. In addition, the channels 126 may be disposed through the base 114, at a location corresponding to the flanges 124, respectively. The channels 126 may extend a length (e.g., in the Z-direction) that is greater than the length of the protrusions 120 and/or the length of the hooks 122. The flanges 124 may also include a length (e.g., in the Z-direction) that is longer than the length of the protrusions 120 and/or the length of the hooks 122.

The pad 100 is shown generally including a rectangular shape. However, other shapes are envisioned (e.g., circular, hexagonal, etc.). In an embodiment, the first side 102 and the second side 104 may be parallel to one another, and/or the first side 102 and the second side 104 may be orthogonal to the third side 106 and the fourth side 108. In an embodiment, the protrusions 120 may be oriented, or extend, in a direction (e.g., between the third side 106 and the fourth side 108). The directionality of the protrusions 120 may be parallel to the first side 102 and the second side 104, and/or perpendicular to the third side 106 and the fourth side 108.

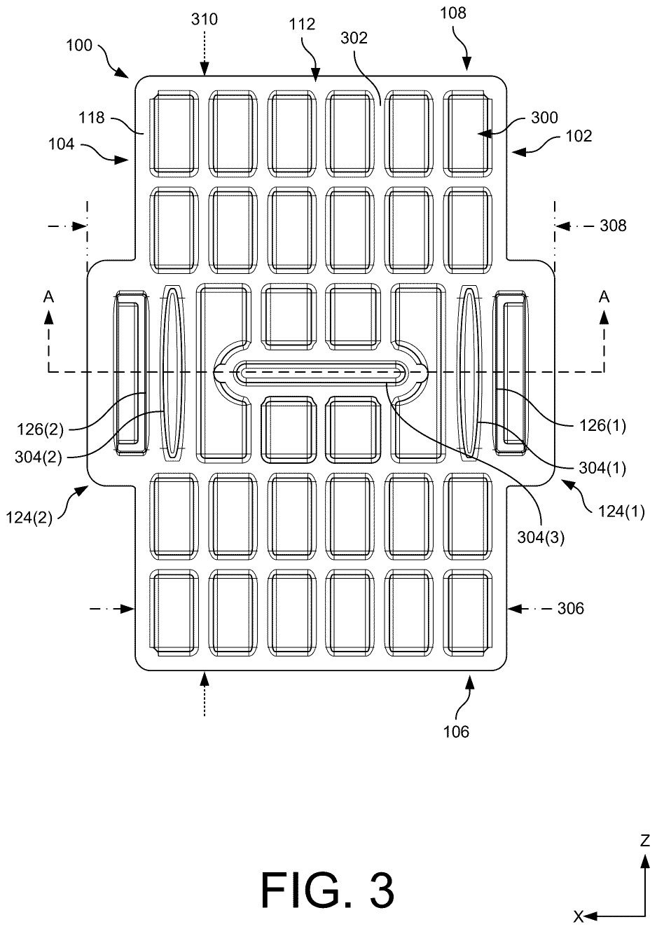

FIG. 3 illustrates a bottom view of the pad 100, according to an embodiment of the present disclosure. The bottom 112, or the bottom surface 118, may define pockets 300. The pockets 300 may represent cavities, voids, etc., formed in the bottom surface 118. The pockets 300 may reduce a weight, material, etc., of the pad 100. Moreover, in an embodiment, the inclusion of the pockets 300 may increase the tackiness of the pad 100 against the surface to prevent the pad 100 from reorienting on the surface. For example, the pockets 300 may permit the bottom surface 118 to conform to the surface, including, for example, undulations in the surface, seams in the surface, etc. Adjacent pockets of the pockets 300 may be separated by sidewalls 302. A plurality of the pockets 300 may be disposed along the bottom 112, the pockets 300 may include any shape and/or configuration, etc. Individual pockets of the pockets 300 may be similar in shape and/or size to one another, or may vary in shape and/or size.

The bottom 112 may also include receptacles 304 for engaging with features of the spacer pads. For example, as will be explained herein, the spacer pads may include protrusions that are configured to be disposed within the receptacles 304, respectively, for securing the spacer pads to the pad 100. The spacer pads may space the pad 100 above the surface to level the rail on the surface or otherwise position the rail on the surface. In an embodiment, the number of the receptacles 304 may be based on the number of the protrusions in the spacer pads. Moreover, a shape, directionality, size, etc., of the receptacles 304 may accommodate the protrusions on the spacer pads.

In an embodiment, the receptacles 304 may include a receptacle 304(1), a receptacle 304(2), and a receptacle 304(3). The receptacle 304(1) and the receptacle 304(2) may be similar to one another. The receptacle 304(1) may be disposed proximate to the first side 102 and the receptacle 304(2) may be disposed proximate to the second side 104. A length and a width of the receptacle 304(1) and the receptacle 304(2) may be defined respectively in the Z-direction and in the X-direction. The receptacle 304(3) may be disposed between the receptacle 304(1) and the receptacle 304(2). The receptacle 304(3) includes a length (e.g., in the X-direction) and a width (e.g., in the Z-direction). The length and the width of the receptacles 304 may accommodate the protrusions of the spacer pads to secure the spacer pads to the pads 100. In an embodiment, the receptacles 304 may have a similar length, a similar width, and/or a similar depth.

In an embodiment, the receptacle 304(1) and the receptacle 304(2) may be oriented in a first direction (e.g., in the Z-direction). The first direction may be defined by a lengthwise direction of the receptacle 304(1) and the receptacle 304(2). The receptacle 304(1) and the receptacle 304(2) may be centrally disposed between the third side 106 and the fourth side 108. In an embodiment, the receptacle 304(3) may be oriented in a second direction (e.g., in the X-direction). The second direction may be defined by a lengthwise direction of the receptacle 304(3). The second direction may be perpendicular to the first direction. As shown, the receptacle 304(3) may be disposed between the receptacle 304(1) and the receptacle 304(2). In an embodiment, the receptacle 304(3) may be similar to the receptacle 304(1) (or the receptacle 304(2)), but may be oriented perpendicular to the receptacle 304(1).

In an embodiment, the receptacle 304(1) may be disposed between the channel 126(1) and the receptacle 304(3). The receptacle 304(2) may be disposed between the channel 126(2) and the receptacle 304(3). The receptacle 304(3) may be centrally disposed between the first side 102 and the second side 104, and/or centrally between the third side 106 and the fourth side 108.

The base 114 may include a first width 306 and a second width 308. The first width 306 may extend between the first side 102 and the second side 104, at locations not corresponding to the flanges 124. The protrusions 120 and the receptacles 304 may be disposed within the first width 306. The second width 308 may extend between the first side 102 and the second side 104, at locations corresponding to the flanges 124. The flanges 124, in other words, may extend from the first side 102 and the second side 104 by a distance corresponding to the second width 308 less the first width 306. The base 114 may also include a length 310 that extends between the third side 106 and the fourth side 108. The first width 306, the second width 308, and/or the length 310 may be based at least in part on the rail.

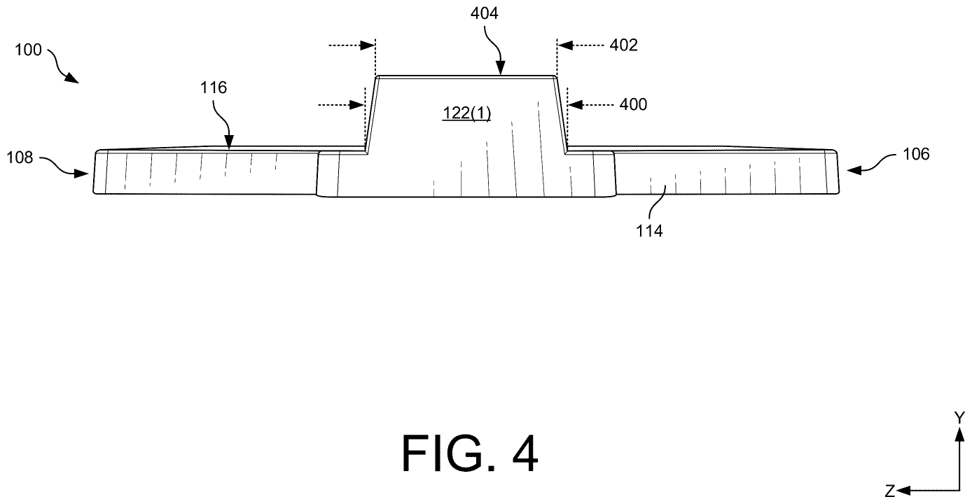

FIG. 4 illustrates a side view of the pad 100, such as the first side 102, according to an embodiment of the present disclosure. The hook 122(1) is disposed along the first side 102 and extends above the top surface 116 of the base 114. The hook 122(1) may include a first dimension 400 (e.g., length) proximate to the top surface 116 and a second dimension 402 (e.g., length) proximate to an end 404 of the hook 122(1). The second dimension 402 may be less than the first dimension 400. The end 404 is spaced apart from the top surface 116 (e.g., in the Y-direction). In this sense, the hook 122(1) may taper inwards (e.g., in the Z-direction) in a direction from the top surface 116 to the end 404. The hook 122(1) may include a height (e.g., in the Y-direction) that extends between the top surface 116 and the end 404.

Although discussed herein with regard to the hook 122(1), the hook 122(2) may be similar to the hook 122(1). The hook 122(1) may be centrally disposed between the third side 106 and the fourth side 108.

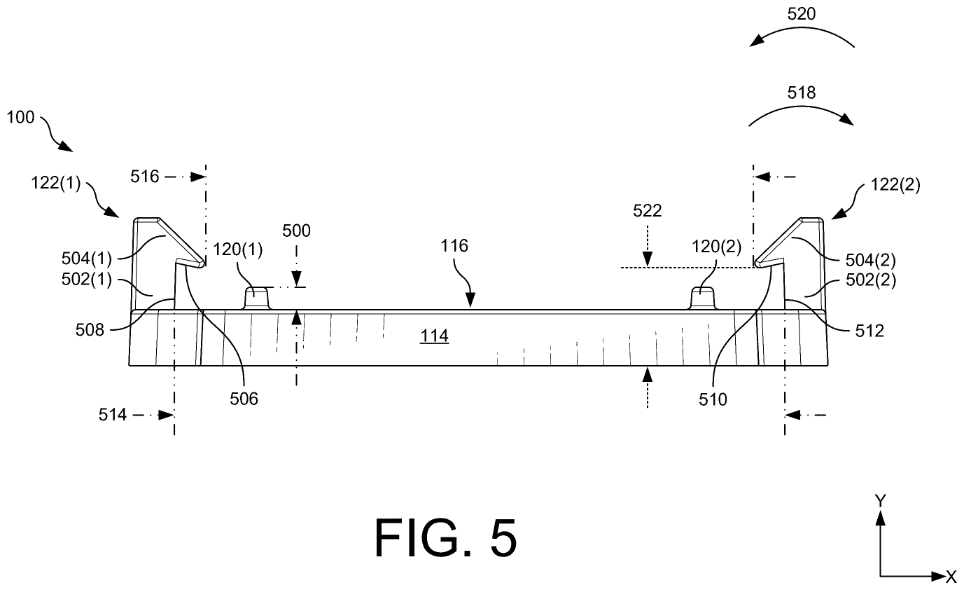

FIG. 5 illustrates a side view of the pad 100, such as the third side 106, according to an embodiment of the present disclosure. The base 114 includes the top surface 116 from which the protrusions 120 extend. The protrusions 120 extend above the top surface 116 by a distance 500. The distance 500 may accommodate the slots in the rail, for example, such that the protrusions 120 extend through the slots in the rail.

The hooks 122 may be defined at least in part by arms 502 and tabs 504, respectively. For example, the hook 122(1) may include an arm 502(1) and a tab 504(1) extending from the arm 502(1). The arm 502(1) is adjoined to and extends from the top surface 116. The tab 504(1) extends transversely from the arm 502(1) to be disposed over the top surface 116. The tab 504(1) may include a surface 506 that engages with the rail to prevent disengagement between the hook 122(1) and the rail. The rail may also engage a surface 508 of the arm 502(1).

Likewise, the hook 122(2) may include an arm 502(2) and a tab 504(2) extending from the arm 502(2). The arm 502(2) is adjoined to and extends from the top surface 116. The tab 504(2) extends transversely from the arm 502(2) to be disposed over the top surface 116. The tab 504(2) may include a surface 510 that engages with the rail to prevent a disengagement between the tab 504(2) and the rail. The rail may also engage a surface 512 of the arm 502(2).

A first distance 514 extends between the surface 508 and the surface 512. The first distance 514 may correspond to a width of the rail. A second distance 516 may extend between a tip of the hook 122(1) and a tip of the hook 122(2). The second distance 516 may be less than the width of the rail, or less than the first distance 514. The hook 122(1) and/or the hook 122(2) may be urged outward in a direction 518 during an attachment of the rail to the pad 100. However, the hook 122(1) and the hook 122(2) may include a natural bias in a direction 520, opposite the direction 518, after moving in the direction 518. In FIG. 4, the hooks 122 are shown in their resting position. The natural position of the hook 122(1) and/or the hook 122(2) in their resting position may maintain engagement between the pad 100 and the rail. In an embodiment, the channel 126(1) and the channel 126(2) may provide the hook 122(1) and the hook 122(2) with the ability, or flexibility, to move in the direction 518 and the direction 520, respectively.

A distance 522 may be disposed between the surface 506 (or the surface 510) and the top surface 116. The distance 522 may be based on a height of the sides of the rail such that the sides of the rail engage with the surface 506 and the surface 510, respectively. Sizes of the base 114, the protrusions 120, the hooks 122, etc., may be different than shown to accommodate differently sized and configured rails.

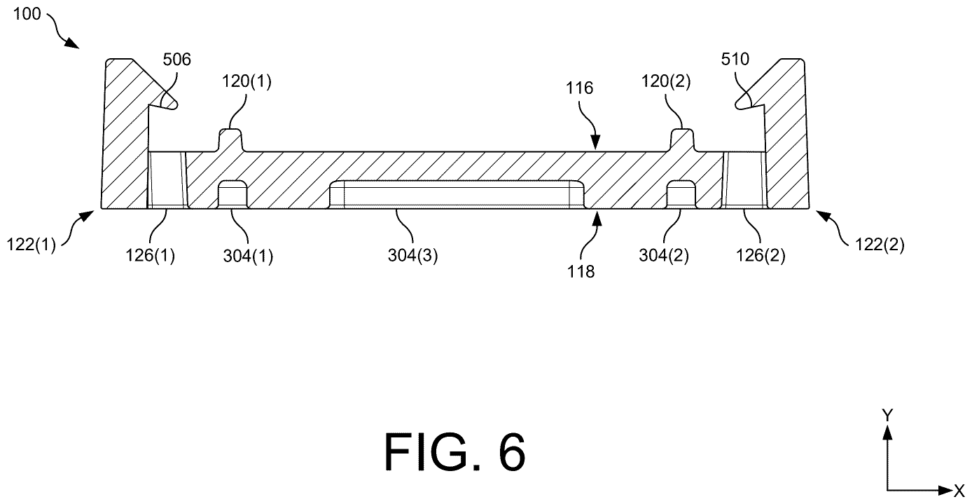

FIG. 6 illustrates a cross-sectional view of the pad 100, taken along line A-A of FIG. 3, according to an embodiment of the present disclosure. The base 114 includes the protrusion 120(1) and the protrusion 120(2) extending above the top surface 116. The receptacle 304(1), the receptacle 304(2), and the receptacle 304(3) are formed in the bottom surface 118. As introduced above, the receptacles 304 receive corresponding features (e.g., protrusions) of the spacer pads. In an embodiment, the protrusion 120(1) may be aligned with the receptacle 304(1) and/or the protrusion 120(2) may be aligned with the receptacle 304(2). The flange 124(1) includes the channel 126(1) and the flange 124(2) includes the channel 126(2). The surface 506 may be disposed above the channel 126(1) and the surface 510 may be disposed above the channel 126(2).

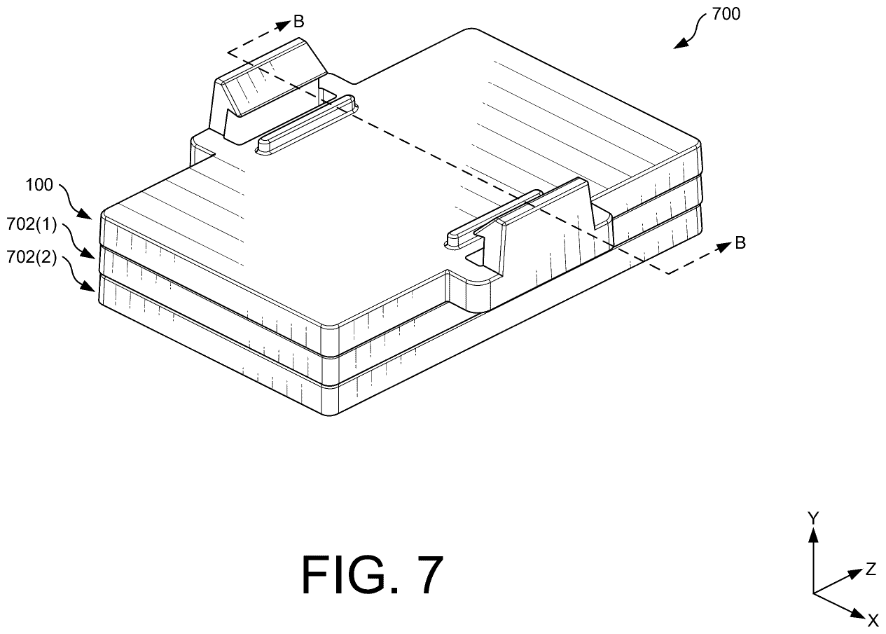

FIG. 7 illustrates an isometric view of an example assembly 700, including the pad 100 and spacer pads 702, according to an embodiment of the present disclosure. Although referred to herein as “spacer pads,” the spacer pads may be referred to as second pads, or simply pads or spacers. As shown in FIG. 7, two of the spacer pads 702 may be attached to the pad 100. For example, a spacer pad 702(1) may attach to the pad 100 and a spacer pad 702(2) may attach to the spacer pad 702(1). Ultimately, the spacer pad 702(2) may be disposed on the surface. However, although two of the spacer pads 702 are shown attached to the pad 100, more than or less than two of the spacer pads 702 may be attached to the pad 100.

Introduced above, and as will be explained herein, the pad 100 may attach to the spacer pads 702 via features of the spacer pad 702(1) being disposed within the receptacles 304. For example, the spacer pad 702(1) may include protrusions that are receivable within the receptacles 304. Moreover, the spacer pad 702(2) may include protrusions that are receivable within receptacles of the spacer pad 702(1) for attaching the spacer pad 702(2) to the spacer pad 702(1). The pad 100 and the spacer pad 702 may be attached together via alternate methods (e.g., snap fit, fasteners, adhesives, etc.).

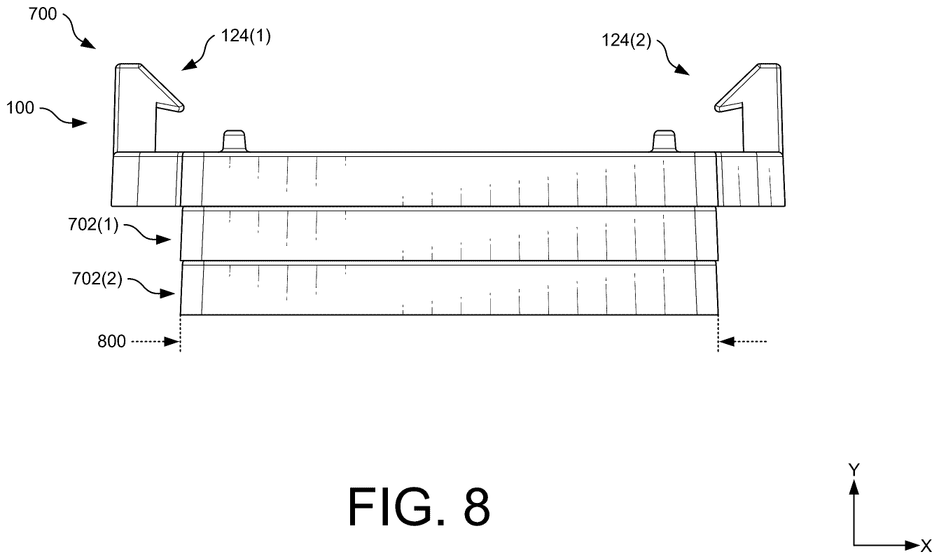

FIG. 8 illustrates a side view of the assembly 700, showing the pad 100 secured to the spacer pads 702, according to an embodiment of the present disclosure. The spacer pads 702 may include a width 800 that is the same as the first width 306. The flange 124(1) and the flange 124(2) may extend beyond the width 800. The flange 124(1) and the flange 124(2) may extend beyond a perimeter of the spacer pads 702. Although the spacer pads 702 are shown including a similar shape as the pad 100, the spacer pads 702 may include a different shape and/or size. For example, the spacer pads 702 may include a width and/or length than the pads 100 to provide support to the pads (e.g., larger base). Moreover, in an embodiment where multiple of the spacer pads 702 are stacked together, the spacer pads 702 themselves may include different shapes and/or sizes.

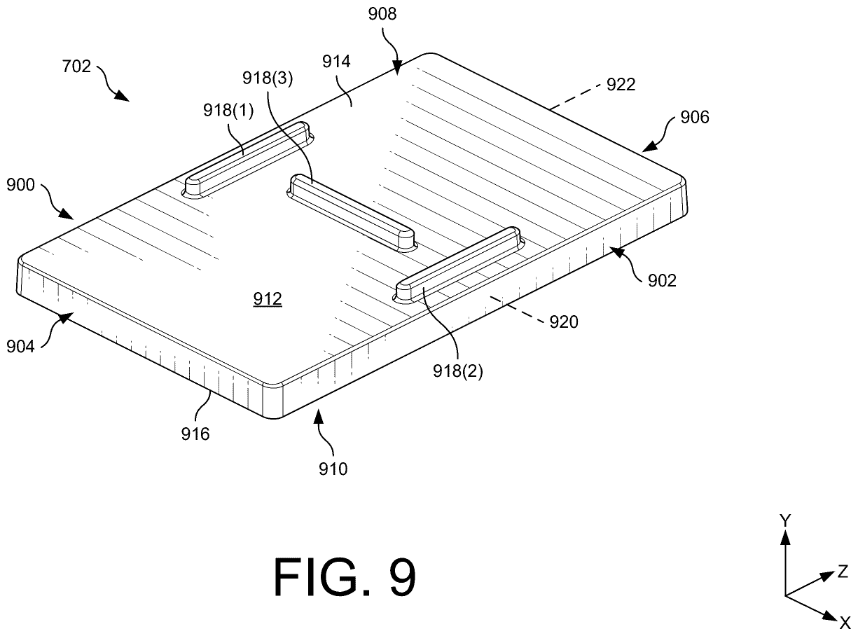

FIG. 9 illustrates an isometric view of the spacer pad 702, according to an embodiment of the present disclosure. The spacer pad 702 may include a first side 900, a second side 902 spaced apart from the first side 900 (e.g., in the X-direction), a third side 904, a fourth side 906 spaced apart from the third side 904 (e.g., in the Z-direction), a top 908, and a bottom 910 spaced apart from the top 908 (e.g., in the Y-direction). The width 800 of the spacer pad 702 extends between the first side 900 and the second side 902. A length of the spacer pad 702 may extend between the third side 904 and the fourth side 906. The width and the length may accommodate the pad 100.

The spacer pad 702 may include a base 912 having a top surface 914 and a bottom surface 916. When the spacer pad 702 corresponds to the spacer pad 702(1), the top surface 914 may be disposed adjacent to the bottom surface 118 of the pad 100. When the spacer pad 702 corresponds to the spacer pad 702(2), the top surface 914 of the spacer pad 702(2) may be disposed adjacent to the bottom surface 916 of the spacer pad 702(1). A plurality of the spacer pads 702 may be attached to the pad 100, or stated alternatively, a plurality of the spacer pads 702 may be stacked together and attached to the pad 100. Regardless, in an embodiment, the bottom surface 916 of a last of the spacer pads 702 (e.g., on the bottom or a bottom most of the spacer pads 702) may be disposed adjacent to the surface.

The spacer pad 702 may include one or more features for engaging the pad 100 and/or the spacer pads 702, respectively. These features may be similar to the features of the pad 100, for example, and may resemble any suitable alignment mechanism, attachment mechanism, key and keyway connectors, male and female connectors, etc. Regardless of the specific embodiment, the features of the spacer pad 702 may engage the pad 100 to seat the spacer pad 702 on the pad 100, and/or may engage the spacer pads 702 to seat the spacer pads 702 on the spacer pads 702. For example, the spacer pad 702 is shown including protrusions 918, such as a protrusion 918(1), a protrusion 918(2), and a protrusion 918(3). The protrusions 918 may represent ribs, projections, spines, etc., that extend above the top surface 914. The protrusions 918 may extend above the top surface 914 by a distance corresponding to a depth of the receptacles 304 (e.g., in the bottom surface 916).

In an embodiment, the protrusions 918 may be disposed with the receptacles 304, respectively. For example, the protrusion 918(1) may be disposed within the receptacle 304(1), the protrusion 918(2) may be disposed within the receptacle 304(2), and the protrusion 918(3) may be disposed within the receptacle 304(3). In an embodiment, the pad 100 and the spacer pad 702 may be press-fit together, snapped together, etc. For example, the protrusions 918 may be pressed or urged into the receptacles 304. An interference fit may be formed between the protrusions 918 and the receptacles 304 to prevent disengagement between the protrusions 918 and the receptacles 304. However, the pad 100 and the spacer pads 702 may be pried apart to remove the protrusions 918 from within the receptacles 304.

In an embodiment, the spacer pad 702 may be symmetrical about a lateral axis 920 (e.g., X-direction) and/or a longitudinal axis 922 (Z-direction). In doing so, the protrusion 918(2) may be disposed within the receptacle 304(1) and the protrusion 918(1) may be disposed within the receptacle 304(2). As will be explained herein, the bottom surface 916 of the spacer pad 702 may include receptacles for receiving the protrusions 918 to attach the spacer pads 702 together (e.g., the spacer pad 702(2) to the spacer pad 702(1)).

Although shown as including three of the protrusions 918, the spacer pad 702 may include more than or less than three of the protrusions 918. However, the pad 100 may include a corresponding number of the receptacles 304 to receive the protrusions 918. In an embodiment, the protrusion 918(1) and the protrusion 918(2) may be oriented in a first direction (e.g., Z-direction), and the protrusion 918(3) may be oriented in a second direction (e.g., X-direction). The second direction may be perpendicular to the first direction. The first direction may be defined by a lengthwise direction of the protrusion 918(1) and the protrusion 918(2). The second direction may be defined by a lengthwise direction of the protrusion 918(3). In an embodiment, the protrusions 918 may be of a similar or different size. Additionally, the shape, configuration, size, number, etc., of the protrusions 918 may be different than shown.

The spacer pad 702 may be manufactured from injection molding, casting, stamping, etc. In an embodiment, the spacer pad 702 may be manufactured from materials such as plastic, rubber, composites, metal, etc. The material of the spacer pad 702 may prevent a reorientation of the spacer pad 702 on the surface. Example materials include Santoprene 201-73, Elastocon 2870, Unisoft TPE ST-70A BK-2-01. In an embodiment, the material of the spacer pad 702 may be similar or the material of the pad 100.

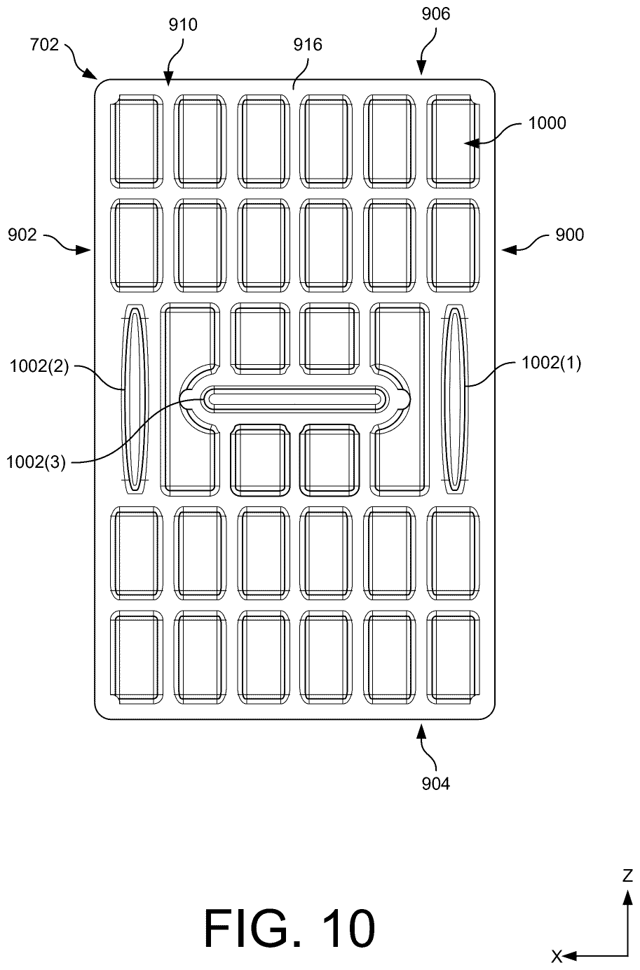

FIG. 10 illustrates a bottom view of the spacer pad 702, according to an embodiment of the present disclosure. The bottom 910, or the bottom surface 916, may define pockets 1000. The pockets 1000 may represent cavities, voids, etc., formed in the bottom surface 916. The pockets 1000 may reduce a weight, material, etc., of the spacer pad 702. Moreover, in an embodiment, the inclusion of the pockets 1000 may increase a tackiness of the spacer pad 702 against the surface to prevent the spacer pad 702, as well as the pad 100 and the rail, reorienting on the surface. Generally, in an embodiment, the bottom 910 of the spacer pad 702 may be similar to the bottom 112 of the pad 100.

The bottom 910 may include receptacles 1002 for engaging with features of the spacer pads 702. In an embodiment, the receptacles 1002 may include a receptacle 1002(1), a receptacle 1002(2), and a receptacle 1002(3). The receptacle 1002(1) and the receptacle 1002(2) may be similar in orientation. For example, the receptacle 1002(1) may be disposed proximate to the first side 900 and the receptacle 1002(2) may be disposed proximate to the second side 902. The receptacle 1002(1) and the receptacle 1002(2) may include a length (e.g., in the Z-direction) and a width (e.g., in the X-direction). The length and the width may accommodate the protrusions 120 of the pad 100 as well as the protrusions 918 of the spacer pads 702. In an embodiment, the receptacle 1002(1) and the receptacle 1002(2) may be oriented in a first direction (e.g., in the Z-direction). The receptacle 1002(1) and the receptacle 1002(2) may be centrally disposed between the third side 904 and the fourth side 906.

The receptacle 1002(3) may be disposed between the receptacle 1002(1) and the receptacle 1002(2). The receptacle 1002(3) may include a length (e.g., in the X-direction) and a width (e.g., in the Z-direction). The length and the width may accommodate the protrusion 918(3) of the spacer pad 702. In an embodiment, the receptacle 1002(3) may be oriented in a second direction (e.g., in the X-direction). The second direction may be perpendicular to the first direction. The first direction of the receptacle 1002(1) and the receptacle 1002(2) may be defined by a lengthwise direction of the receptacle 1002(1) and the receptacle 1002(2). The second direction of the receptacle 1002(3) may be defined by a lengthwise direction of the receptacle 1002(3). As shown, the receptacle 1002(3) may be disposed between the receptacle 1002(1) and the receptacle 1002(2).

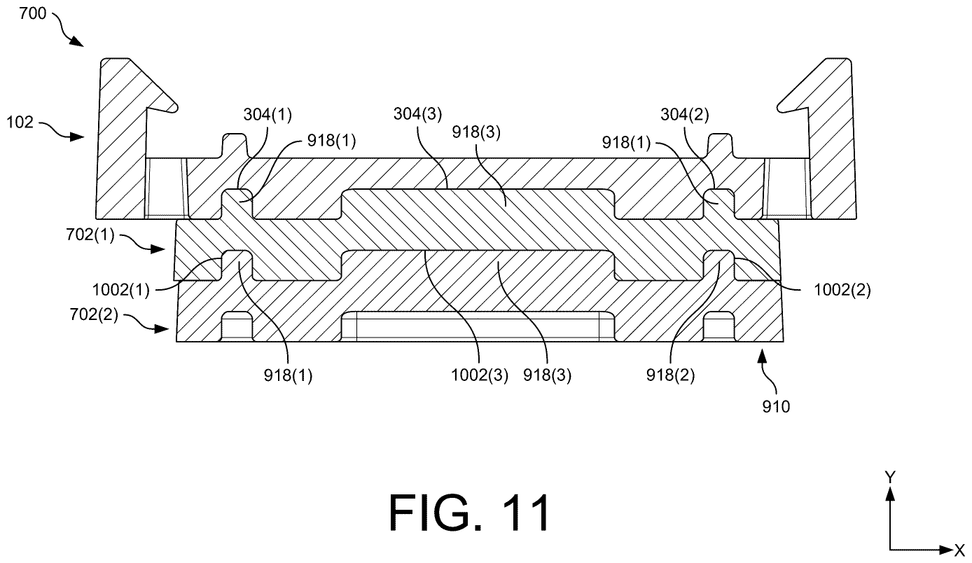

FIG. 11 illustrates a cross-sectional view of the assembly 700, taken along line B-B of FIG. 7, according to an embodiment of the present disclosure. As introduced above, the pad 100 may attach to the spacer pads 702, and/or the spacer pads 702 may attach to one another (e.g., as a stack). For example, the protrusion 918(1) of the spacer pad 702(1) may be disposed within the receptacle 304(1) of the pad 100, the protrusion 918(2) of the spacer pad 702(1) may be disposed within the receptacle 304(2) of the pad 100, and the protrusion 918(3) of the spacer pad 702(1) may be disposed within the receptacle 304(3) of the pad 100.

In addition, the protrusion 918(1) of the spacer pad 702(2) may be disposed within the receptacle 1002(1) of the spacer pad 702(1), the protrusion 918(2) of the spacer pad 702(2) may be disposed within the receptacle 1002(2) of the spacer pad 702(1), and the protrusion 918(3) of the spacer pad 702(2) may be disposed within the receptacle 1002(3) of the spacer pad 702(2). The bottom 910 of the spacer pad 702(2) may be disposed against the surface.

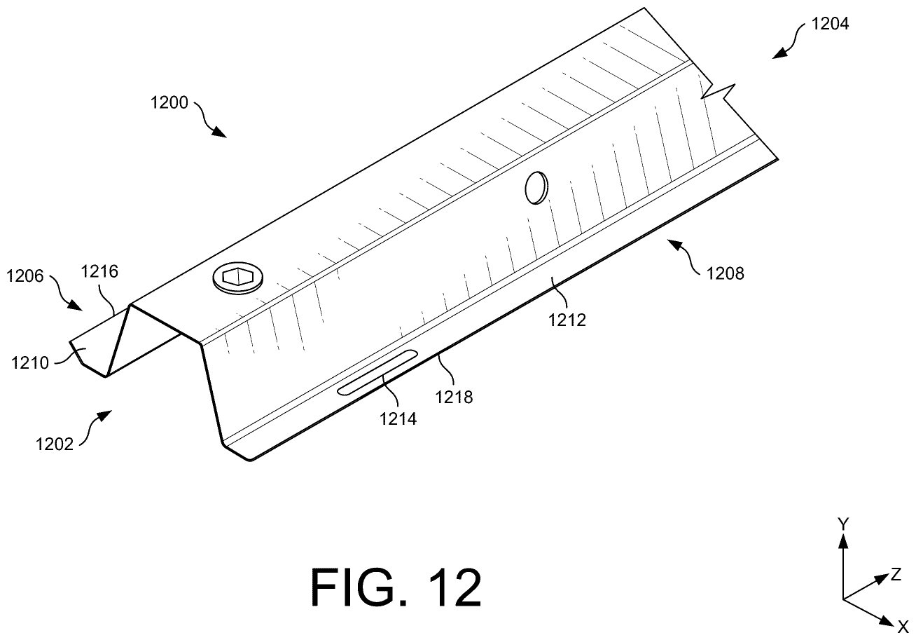

FIG. 12 illustrates an example rail 1200 that may attach to the pad 100, according to an embodiment of the present disclosure. The rail 1200 may represent an elongated member, for example, such as an extruded piece of material. The rail 1200 may include a first end 1202 and a second end 1204 spaced apart from the first end 1202 (e.g., in the Z-direction). The rail 1200 may include a first side 1206 and a second side 1208 spaced apart from the first side 1206 (e.g., in the X-direction). A width of the rail 1200 extends between the first side 1206 and the second side 1208. The first distance 514 that extends between the surface 508 and the surface 512 accommodates the width of the rail 1200.

The rail 1200 may include a flange 1210 disposed on the first side 1206 and a flange 1212 disposed on the second side 1208. The flange 1210 and the flange 1212, or more generally, a bottom of the rail 1200, may rest on the top surface 116 of the base 114. The flange 1210 and the flange 1212 may also define a slot to receive the protrusions 120 of the pad 100, respectively. For example, the flange 1210 may include a slot (hidden in FIG. 12) and the flange 1212 may include a slot 1214. The slot in the flange 1210 may be similar to the slot 1214. The slots of the flange 1210 and the flange 1210 may represent channels, grooves, etc.

The hooks 122 of the pad 100 may engage with the flange 1210 and the flange 1212. For example, an edge 1216 of the flange 1210 may be disposed against the surface 506 of the tab 504(1) and/or the surface 508 of the arm 502(1). An edge 1218 of the flange 1212 may be disposed against the surface 510 of the tab 504(2) and/or the surface 512 of the arm 502(2).

Although a particular shape of the rail 1200 is shown, other variations are envisioned. For example, rails with different shapes, configurations, etc., may attach to the pad 100. Moreover, depending upon the shapes, configurations, etc., of the rail 1200, the pad 100 may be configured accordingly. For example, the protrusions 120 and/or the hooks 122 may be differently shaped, located, etc., to attach to other rails. In addition, more than one of the pads 100 may be attached to the rail 1200. In such instances, the rail 1200 may include additional slots for attaching to the pad 100.

Although not shown, one or more solar panel modules may be attached to the rail 1200, whether directly or indirectly. For example, one or more clamps, mounts, brackets, etc., may be used to attach the solar panel modules to the rail 1200. In addition, a plurality of the rails 1200 may be used to support the solar panel modules above the surface.

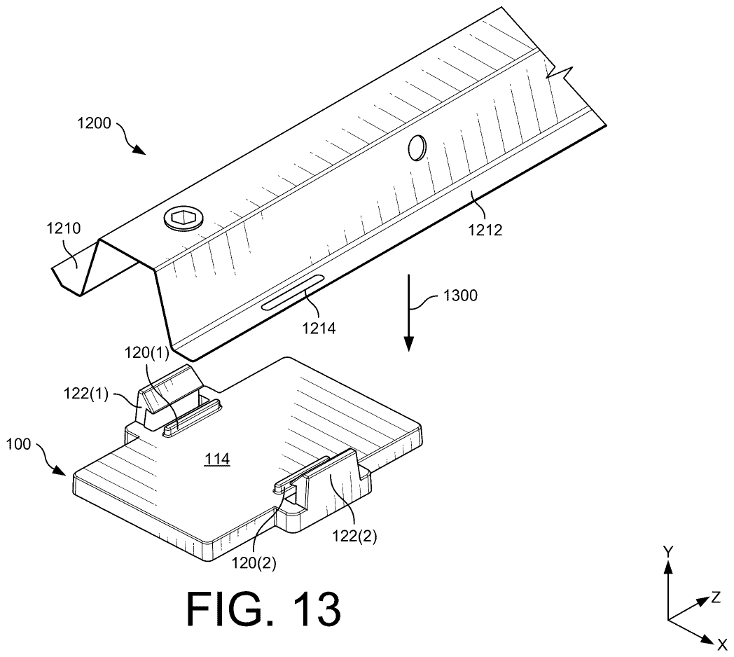

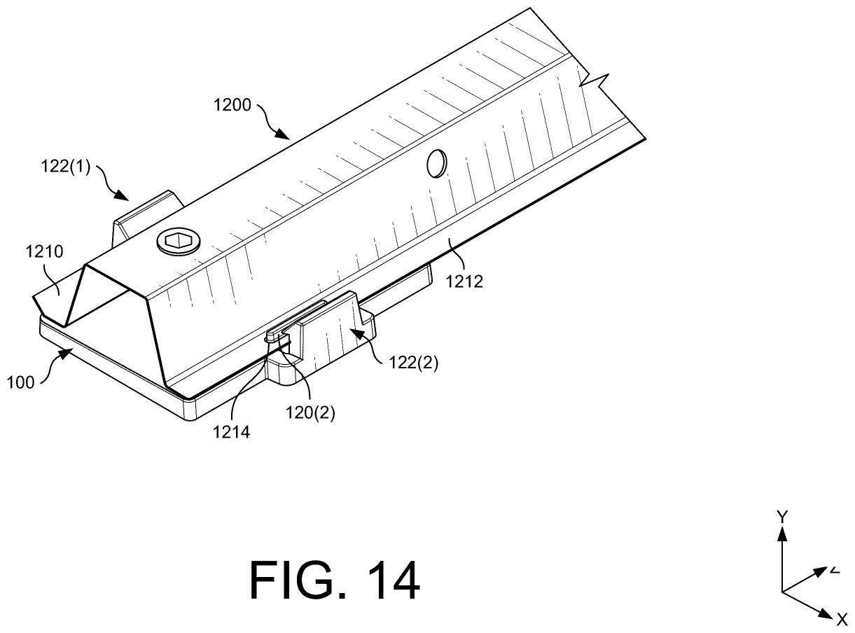

FIGS. 13 and 14 illustrate an example attachment between the rail 1200 and the pad 100, according to an embodiment of the present disclosure. In an embodiment, the rail 1200 may be advanced in a direction 1300 to dispose the rail 1200 on the pad 100. During this, the protrusion 120(1) becomes disposed within the slot on the flange 1210, and the protrusion 120(2) becomes disposed within the slot 1214 of the flange 1212. In addition, the hook 122(1) engages with the flange 1210 and the hook 122(2) engages with the flange 1212.

In an embodiment, the rail 1200 may be rotated, twisted, translated, or otherwise manipulated to secure the rail 1200 to the pad 100. For example, in an embodiment, the flange 1210 may be disposed within the hook 122(1), and thereafter, the rail 1200 may be rotated to secure the flange 1212 within the hook 122(2). In an embodiment, an installer may urge the hook 122(1) and/or the hook 122(2) in the direction 518, for example, during an attachment of the rail 1200 to the pad 100.

In an embodiment, the pad 100 and the rail 1200 may be used with ballasted flat-roof systems. As introduced above, the pad 100 may increase a coefficient of friction between the rail 1200 and the surface. In an embodiment, a coefficient of friction between the pad 100 and the surface may be at least 0.4.

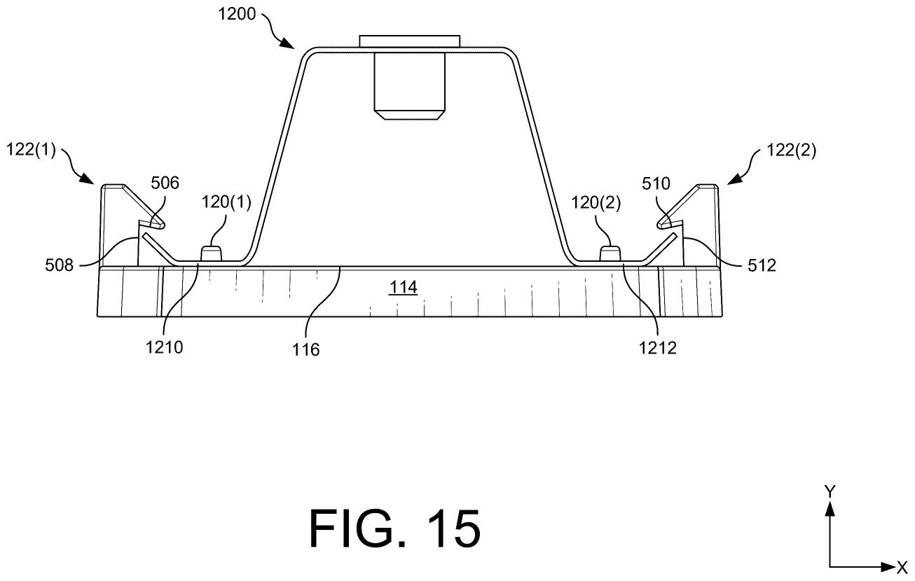

FIG. 15 illustrates an end view, showing the pad 100 engaged with the rail 1200, according to an embodiment of the present disclosure. The pad 100 and the rail 1200 engage via the hooks 122 engaging with features of the rail 1200. For example, the rail 1200 may be attached to the pad 100 via the flange 1210 being disposed within the hook 122(1) and via the flange 1212 being disposed within the hook 122(2). More particularly, the flange 1210 may be at least partially retained within the surface 506 and the surface 508, while the flange 1212 may be at least partially retained within the surface 510 and the surface 512. In addition, the protrusion 120(1) may be disposed within the slot on the flange 1210 and the protrusion 120(2) may be disposed within the slot 1214 on the flange 1212. The distance 500 of the protrusions 120 may accommodate a thickness of the rail 1200 such that the protrusions 120 extend through the slots in the rail 1200. The flange 1210 and the flange 1212 may also rest on the top surface 116 of the base 114. The hooks 122 may be urged in the direction 518 remove the rail 1200 from the pad 100.

In addition, and although not shown, the spacer pads 702 may be attached to the pad 100. For example, one or more of the spacer pads 702 may attach to the pad 100, or to one another, as discussed above. The spacer pads 702 may be used level the rail 1200, and consequentially, the solar panel modules on the surface.

As used herein, terms such as “attached,” “fastened,” “secured,” “disposed,” “connected,” and “coupled” (including variations thereof) are intended to be used interchangeably to refer to any form of interaction between components, whether directly or indirectly, permanently or temporarily, mechanically or otherwise. It will be understood that these terms are not intended to limit the nature of the interaction to a direct or immediate connection unless specifically stated, and may include indirect connections through one or more intermediary elements. Likewise, the terms “directly” and “indirectly” describe both physical contact between components and connections made through intermediate structures, mechanisms, or devices.

While various examples and embodiments are described individually herein, the examples and embodiments may be combined, rearranged, and modified to arrive at other variations within the scope of this disclosure.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

1. An assembly comprising:
a first pad including:
a base having a top surface and a bottom surface,
a first side,
a second side opposite the first side of the first pad,
a first hook disposed on the top surface of the base of the first pad at the first side, the first hook to engage a first side of a rail that supports one or more solar panel modules,
a second hook disposed on the top surface of the base of the first pad at the second side, the second hook to engage a second side of the rail opposite the first side of the rail,
a cross-sectional dimension extending between the first side of the first pad at a location corresponding to the first hook and the second side of the first pad at a location corresponding to the second hook,
a protrusion disposed on the top surface of the base of the first pad, the protrusion of the base of the first pad to engage a slot of the rail, and
a receptacle disposed on the bottom surface of the base of the first pad; and
a second pad to attach to the first pad, the second pad including:
a base having a top surface and a bottom surface,
a first side disposable adjacent to the first side of the first pad,
a second side opposite the first side of the second pad, the second side of the second pad disposable adjacent to the second side of the first pad,
a cross-sectional dimension extending between the first side of the second pad and the second side of the second pad, the cross-sectional dimension of the second pad being less than the cross-sectional dimension of the first pad.
a protrusion disposed on the top surface of the base of the second pad, the protrusion of the second pad to engage within the receptacle disposed on the bottom surface of the base of the first pad, and
a receptacle disposed on the bottom surface of the base of the second pad.

2. The assembly of claim 1, wherein the first pad further includes:
a second protrusion disposed on the top surface of the base of the first pad, the second protrusion of the first pad to engage a second slot of the rail;
a second receptacle disposed on the bottom surface of the base of the first pad; and
a third receptacle disposed on the bottom surface of the base of the first pad.

3. The assembly of claim 2, wherein the second pad further includes:
a second protrusion disposed on the top surface of the base of the second pad, the second protrusion of the second pad to engage within the second receptacle disposed on the bottom surface of the base of the first pad; and
a third protrusion disposed on the top surface of the base of the second pad, the third protrusion of the second pad to engage within the third receptacle disposed on the bottom surface of the base of the first pad.

4. The assembly of claim 3, wherein:
the protrusion disposed on the top surface of the base of the first pad is oriented in a first direction;
the protrusion disposed on the top surface of the base of the second pad is oriented in the first direction;
the second protrusion disposed on the top surface of the base of the first pad is oriented in the first direction;
the second protrusion disposed on the top surface of the base of the second pad is oriented in the first direction; and
the third protrusion disposed on the top surface of the base of the second pad is oriented in a second direction, the second direction being perpendicular to the first direction.

5. The assembly of claim 1, further comprising a third pad to attach to the second pad, the third pad including a protrusion to engage within the receptacle disposed on the bottom surface of the base of the second pad.

6. The assembly of claim 1, wherein:
the first pad further includes:
a first flange,
a second flange,
a first channel disposed through the first flange, between the top surface and the bottom surface, and
a second channel disposed through the second flange, between the top surface and the bottom surface;
the first hook is disposed on the first flange; and
the second hook is disposed on the second flange.

7. An apparatus comprising:
a base including:
a top surface to receive a rail, and
a bottom surface opposite the top surface;
a first protrusion disposed on the top surface, the first protrusion to be disposed through a first slot of the rail;
a second protrusion disposed on the top surface, the second protrusion to be disposed through a second slot of the rail;
a first hook disposed on the top surface, the first hook to engage the rail;
a second hook disposed on the top surface, the second hook to engage the rail;
a first receptacle disposed in the bottom surface; and
a second receptacle disposed in the bottom surface.

8. The apparatus of claim 7, further comprising a third receptacle disposed in the bottom surface, the third receptacle being located between the first receptacle and the second receptacle.

9. (canceled)

10. The apparatus of claim 7, further comprising:
a first flange extending from the base; and
a second flange extending from the base,
wherein:
the first hook is disposed on the first flange, and
the second hook is disposed on the second flange.

11. The apparatus of claim 7, further comprising:
a first channel disposed through the base, at a location between the first hook and the first protrusion; and
a second channel disposed through the base, at a location between the second hook and the second protrusion.

12. (canceled)

13. The apparatus of claim 7, wherein the first receptacle and the second receptacle receive respective protrusions of a second apparatus that attaches to the apparatus.

14. The apparatus of claim 7, wherein:
the first protrusion is aligned with the first receptacle; and
the second protrusion is aligned with the second receptacle.

15. A first pad comprising:
a base;
a first hook to engage a first side of a rail that supports a solar panel module, the first hook extending from the base by a first distance;
a second hook to engage a second side of the rail, the second hook extending from the base by the first distance;
a first protrusion to be at least partially disposed through a first slot of the rail, the first protrusion extending from the base by a second distance that is less than the first distance;
a second protrusion to be at least partially disposed through a second slot of the rail, the second protrusion being parallel to the first protrusion, the second protrusion extending from the base by the second distance;
a first receptacle to engage a first protrusion of a second pad; and
a second receptacle to engage a second protrusion of the second pad.

16. The first pad of claim 15, wherein the first protrusion and the second protrusion are disposed between the first hook and the second hook.

17. The first pad of claim 15, wherein:
the base includes a top surface and a bottom surface opposite the top surface;
the first hook, the second hook, the first protrusion, and the second protrusion are disposed on the top surface; and
the first receptacle and the second receptacle are disposed on the bottom surface.

18. The first pad of claim 15, further comprising a third receptacle to engage a third protrusion of the second pad.

19. The first pad of claim 15, wherein:
the first receptacle is aligned with the first protrusion of the first pad; and
the second receptacle is aligned with the second protrusion of the first pad.

20. The first pad of claim 15, further comprising:
a first flange;
a second flange;
a first channel disposed through the first pad, at a location between the first hook and the first protrusion; and
a second channel disposed through the first pad, at a location between the second hook and the second protrusion,
wherein:
the first hook is disposed on the first flange, and
the second hook is disposed on the second flange.

21. The apparatus of claim 7, wherein a portion of the rail is disposable beyond a perimeter of the base.

22. The apparatus of claim 7, wherein the first protrusion, the second protrusion, the first hook, and the second hook are independent features of the apparatus.
